(19) United States
(12) Patent Application Publication
(10) Pub. No.: US 2006/0273731 A1
(43) Pub. Date: Dec. 7, 2006

(54) High Power Cold Cathode Tubular Fluorescent Lamp

(75) Inventor: Shichao Ge, San Jose, CA (US)

Correspondence Address: PARSONS HSUE & DE RUNTZ LLP, 595 MARKET STREET, SUITE 1900, SAN FRANCISCO, CA, 94105, US

(73) Assignee: TBT Asset Management International Limited, Tortola (VG)

(21) Appl. No.: 11/422,320

(22) Filed: Jun. 5, 2006

(30) Foreign Application Priority Data
Jun. 6, 2005 (CN) 200520102770.3
Jul. 18, 2005 (CN) 200520013346.1
Sep. 19, 2005 (CN) 200520015008.1
Dec. 2, 2005 (CN) 200520117017.1
Dec. 26, 2005 (CN) 200520134334.4

(51) Int. Cl. H01K 1/62

(52) U.S. Cl. 315/57

(57) ABSTRACT

A high power tubular CCFL device comprises at least one CCFL; and a light transmission tube having two ends, where the at least one CCFL is at a fixed location inside the light transmission tube. At least two fixtures are used, one fixture at each of the two ends of the light transmission tube. At least two connectors are used, one connector at each of the two ends of the light transmission tube for connection to input electric power. Preferably a portion of a driver (which preferably includes at least one high voltage transformer) is employed in the fixture. The fixture connects the light transmission tube, the CCFL(s) and the connector. When input electric power is supplied to the connector, the portion of the driver (e.g. at least one high voltage transformer) will cause suitable voltage to be supplied to cause the CCFL to supply light. The above described CCFL device is suitable for replacing the hot cathode. To design a CCFL device that generates multi-color lighting for various purposes such as entertainment, two or more CCFLs may be used. A driver circuit converts input electric power to an AC output in the range of about 5-400 volts and at a frequency in the range of about 1 kc-800 kc. At least one high voltage transformer responds to said AC output to cause suitable voltage(s) to be supplied to each of the CCFLs to cause the CCFLs to supply light. In one embodiment, a plurality of CCFL lamp units are used, each equipped with its own driver control circuit that supplies a suitable voltage to the CCFL of such unit. Hence, the driver circuits applying AC outputs to the two or more CCFL lamp units may apply AC outputs that are different from one another, so that the two or more CCFL units are individually controlled to emit light of the same or different intensities.

### CLAIM OF FOREIGN PRIORITY

This application claims the benefit of the following foreign applications: Chinese Application No. 200520102770.3, filed Jun. 6, 2005; Chinese Application No. 200520013346.1, filed Jul. 18, 2005; Chinese Application No. 200520015008.1, filed Sep. 19, 2005; Chinese Application No. 200520117017.1, filed Dec. 2, 2005; and Chinese Application No. 200520134334.4, filed Dec. 26, 2005.

### BACKGROUND OF THE INVENTION

1. Field of the Invention

The present invention relates generally to a cold cathode fluorescent lamp and more particularly, to a high power tubular cold cathode fluorescent lamp for lighting.

2. Description of the Prior Art

The existing high power tubular fluorescent lamps (FL), e.g., T12, T10, T8, T5 and T4 FL etc. are the hot cathode FL. It has been used for lighting beginning around 1940, and is widely used in the world now. It has the advantages of high efficiency, low cost and able to generate different color light. However, it has a short operating lifetime, very short ON/OFF switching lifetime, and dimming the hot cathode FL is difficult to implement, especially when dimming through a wide range of light intensities or when linear dimming is desired. It is also, difficult to control and change the color of light emitted by the hot cathode FL or to change its color temperature.

The cold cathode fluorescent lamp (“CCFL”) has long operating lifetime, very long ON/OFF switching lifetime and high efficiency. It is widely used for LCD backlight, and some claims that the lifetime of CCFLs can be up to 60,000 hours. At the same time, industry has started to use the CCFL for low power lighting applications. However, the current state of CCFL technology is still unable to make a high power tubular fluorescent lamp for replacement of the current high power hot cathode FL. Chinese Patent No. 00129116.5 discloses a simple type of the tubular cold cathode fluorescent lamp (CCFL lamp). It is a possible approach for making high power tubular Fluorescent lamp (FL). However, the length of the CCFL tube in the lamp is short and the efficiency is low. At the same time, it needs a high voltage for the CCFL lamp driving, and there may be safety concerns when using such lamp.

### SUMMARY OF THE INVENTION

According to one aspect of the invention, a high power tubular CCFL device comprises at least one CCFL; and a light transmission tube having two ends, where the at least one CCFL is at a fixed location inside the light transmission tube. At least two fixtures are used, which are located, one at each end of the light transmission tube. At least two connectors are employed, one at each end of the light transmission tube for connection to input electric power. A driver is used having a portion located in one of the fixtures. Preferably, such portion includes at least one high voltage transformer. The fixture connects the light transmission tube, the CCFL(s) and the connector. When input electric power is supplied to the connector, the at least one high voltage transformer will cause suitable voltage to e supplied to cause the CCFL to supply light.

The above described CCFL device is suitable for replacing the hot cathode FL. For example, the shape and size of the CCFL device may be chosen such that it will fit into spaces that may be suitable for the hot cathode FL.

In one embodiment of such CCFL device, such device comprises at least two CCFLs: at least one high color temperature light tube and at least one low color temperature light tube, or at least one low color temperature light tube and at least one green-blue color light tube. By using one or more drivers to control power supplied to the CCFLs to change the relative light intensities of the light emitted by the high and low color temperature CCFL tubes, or the low color temperature light tube and the green-blue color light tubes to obtain different color temperature light, it is possible to design the device as a light color temperature adjustable lamp and/or a color temperature adjustable and dimmable lamp.

In addition to using the above CCFL device arrangement for lighting applications as a replacement for the hot cathode FL, it is also possible to design a CCFL device that generates multi-color lighting for various purposes such as entertainment. For this purpose, two or more CCFLs may be used. A driver circuit converts input electric power to an AC output in the range of about 5-400 volts and at a frequency in the range of about 1 kc-800 kc. At least one high voltage transformer responds to said AC output to cause suitable voltage(s) to be supplied to each of the CCFLs to cause the CCFLs to supply light. In one embodiment, a plurality of CCFL lamp units are used, each equipped with its high voltage transformer(s) that supplies a suitable voltage to the CCFL(s) of such unit. Hence, one or more driver circuits applying AC outputs to the two or more CCFL lamp units may apply AC outputs that are different from one another, so that the two or more CCFL units are individually controlled to emit light of the same or different intensities.

In one embodiment, a single driver is used to control the electric power supplied to more than one CCFL unit, where each unit has it own high voltage transformer(s). In an alternative embodiment, multiple drivers are used, one for each unit, where each unit has it own high voltage transformer(s). The CCFLs may be enclosed within the same light transmission tube, or its own light transmission tube. The CCFLs in the units may emit light of the same color for high intensity applications, or different color light for entertainment purposes.

Since the light power emitted by a CCFL is proportional to its length, it is desirable to employs CCFLs that have longer lengths. Preferably, the CCFLs used in the embodiments are not straight to increase their length, while being able to fit the resulting lamp device within practical dimensions. The hot cathode FL usually is about two feet in length. The CCFLs in the shape of a straight line of only two feet may not be able to emit adequate light for high power applications. Preferably the CCFLs may be U or H shaped, or another shape that is not a straight line to increase their length, while being able to fit the resulting lamp device within practical dimensions, such as a space of only two feet in length.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention. In the drawings;

FIG. 1 is a schematic drawing showing an embodiment of the high power tubular cold cathode fluorescent lamp according to the present invention.

FIG. 2 is a cross sectional view of FIG. 1 along the line A-A in FIG. 1.

FIG. 3 is a schematic drawing showing an alternative embodiment of the high power tubular cold cathode fluorescent lamp according to the present invention.

FIG. 4 is a cross sectional view of FIG. 3 along the line B-B in FIG. 3.

FIG. 5 is a schematic drawing showing a third alternative embodiment of the high power tubular cold cathode fluorescent lamp according to the present invention.

FIG. 6 is a cross sectional view of FIG. 5 along the line C-C in FIG. 5.

FIG. 7 is a schematic drawing showing a fourth alternative embodiment of the high power tubular cold cathode fluorescent lamp according to the present invention.

FIG. 8 is a cross sectional view showing yet an alternative embodiment of the high power tubular cold cathode fluorescent lamp according to the present invention.

FIG. 9 is a cross sectional view showing still another alternative embodiment of the high power tubular cold cathode fluorescent lamp according to the present invention.

FIG. 10 is a cross sectional view showing one more alternative embodiment of the high power tubular cold cathode fluorescent lamp according to the present invention.

FIG. 11 is a cross sectional view showing another alternative embodiment of the high power tubular cold cathode fluorescent lamp according to the present invention.

FIG. 12 is a cross sectional view showing another alternative embodiment of the high power tubular cold cathode fluorescent lamp according to the present invention.

FIG. 13 is a schematic drawing showing an embodiment of the high power tubular cold cathode fluorescent lamp with the driver and the base according to the present invention.

FIG. 14 is a schematic drawing showing an alternative embodiment of the high power tubular cold cathode fluorescent lamp with the driver and the base according to the present invention.

FIG. 15 is a schematic drawing showing an alternative embodiment of the high power tubular cold cathode fluorescent lamp with the driver and the base according to the present invention.

FIG. 16 is a schematic drawing showing an alternative embodiment of the high power tubular cold cathode fluorescent lamp with a controller and one driver drives one or more CCFL lamps according to the present invention.

FIG. 17 is a schematic drawing showing an alternative embodiment of the high power tubular cold cathode fluorescent lamp with the one driver drives one or more CCFL lamps according to the present invention.

FIG. 18A is a schematic drawing showing an alternative embodiment of the high power tubular cold cathode fluorescent lamp with CCFLs that are bent near one end, so as to avoid dark ends.

FIG. 18B is a cross sectional view of FIG. 18A along the line 18B-18B in FIG. 18A.

FIG. 19 is a schematic drawing showing another alternative embodiment of the high power tubular cold cathode fluorescent lamp with CCFLs that are bent near one end, so as to avoid dark ends, where the CCFLs are placed in a tandem arrangement.

FIG. 20 is a schematic drawing showing a (1+½)U shaped CCFL to illustrate an embodiment of the high power tubular cold cathode fluorescent lamp.

FIG. 21 is a schematic drawing showing a (1+½)H shaped CCFL to illustrate an embodiment of the high power tubular cold cathode fluorescent lamp.

FIG. 22 is a schematic drawing showing a serpentine shaped CCFL to illustrate an embodiment of the high power tubular cold cathode fluorescent lamp.

For simplicity in description, identical components are labeled by the same numerals in this Application.

### DETAILED DESCRIPTION OF THE PREFERRED EMBODIMENTS

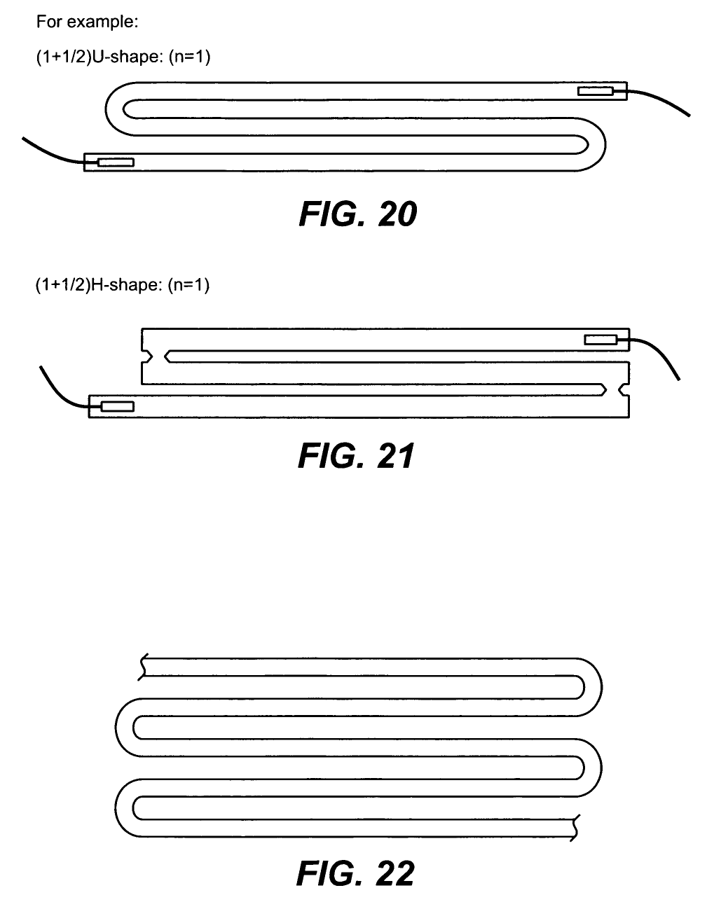

The present invention provides a high power, high efficiency and high output luminous flux CCFL tubular FL, which can replace the existing high power tubular hot cathode FL. In one embodiment, it comprises at least one “U” shape, multi-“U” shape CCFL or at least one “(n+½)U” shape CCFL tube. The case of a “(n+½)U” shape CCFL tube, where n=1 is illustrated in FIG. 20. Thus, if one side of the U-shape has a length of two feet, then the total length of the U-shaped CCFL tube is 4 feet. In order to further increase its length, one end of the U-shaped CCFL tube may be further extended but bent in a direction to form a serpentine shape illustrated in FIG. 20, which comprises a U-shape plus one half of a U-shape. Thus, if a two feet long CCFL emits light at 6 watts, then a U-shaped CCFL tube whose two prongs are two feet long each will emit light at 12 watts. By adopting the shape of the CCFL in FIG. 20, the length of the CCFL is increased by another two feet, so that the CCFL will emit light at 18 watts. If it is desired to further increase the length of the CCFL, the CCFL can take on a serpentine shape, which comprises a number of U-shaped tubes connected at their ends to form a single serpentine shaped CCFL tube as illustrate in FIG. 22. The same technique as that described above in reference to FIG. 20 may be used to further extend the length by ½ U, so as to form a“(n+½)U” shape CCFL tube, with n=2 or a larger integer than 2. Where two or more straight CCFL tubes are connected at points not at the ends to form a single CCFL tube, an H-shaped CCFL tube results, as illustrated in FIG. 21. As shown in FIG. 21, three straight CCFL tubes are connected to form a (1+½)H shaped tube. In one embodiment, the total length of the one or more CCFLs enables them to emit light at at least 24 watts. The total length of the one or more CCFLs may be not less than 8 feet.

A large light transmission glass (or plastic) tube may be used to house the one or more CCFLs. The CCFLs are fixed in the glass tube. The glass tube can be transparent, light diffusive or light transmissive only of light of certain colors. At least one connector at each end of the glass tube is used for connection to input driving voltage. In this case, a longer CCFL tube can be used to increase efficiency, because the longer CCFL tube, the higher luminous efficiency. At the same time, by adjusting the CCFL power and the diameter and length of the light transmission glass tube, the CCFL device may operate at its optimal temperature and optimal efficiency of the CCFL lamp.

One embodiment of the present invention enables improved reliability of the CCFL lamp. As we know that the CCFL needs a high voltage for driving, e.g., 300-3000V, and at least one high transformer is needed in its driver. In the present invention, said high voltage transformer may be located near the electrodes of the CCFLs which are at the ends of the light transmission glass tube to improve the reliability of the lamp. Also, multiple high voltage transformers connected in series can be used to replace a single high voltage transformer to further reduce the voltage requirement. Thus, where a 3000 volts voltage is called for to power a CCFL, if two high voltage transformers connected in series are used, each of the two transformers will need to supply only 1500 volts output, instead of 3000 volts.

In another embodiment, the lamp can be dimmed throughout a wide range, e.g., 1-100%, continually and linearly.

In still one more embodiment, the color temperature of lamp can be adjusted. In this case, there are at least two different color CCFL tubes installed in the light transmission tube. The at least two CCFL tubes can be at least one high color temperature and at least one low color temperature lamp, or at least one low color temperature and at least one green-blue. To adjust the light intensity of the different color CCFL tubes, the color temperature of the tubular cold cathode FL can be adjustable.

In yet another embodiment of the present invention, the light color of the CCFL lamp can be adjusted. Said at least one CCFL tube can be at least one set of red, green and blue CCFL tubes, or other colors CCFLs. To adjust the light intensity of the different color lamps, the different color or color variable tubular CCFL lamp can be obtained.

In still one more embodiment, the driver of the CCFL lamp is separated into two portions, one is installed in the lamp light transmission tube, and the other is in the base of the lamp support.

In another embodiment, one driver drives one CCFL lamp or drives two or more CCFL lamps.

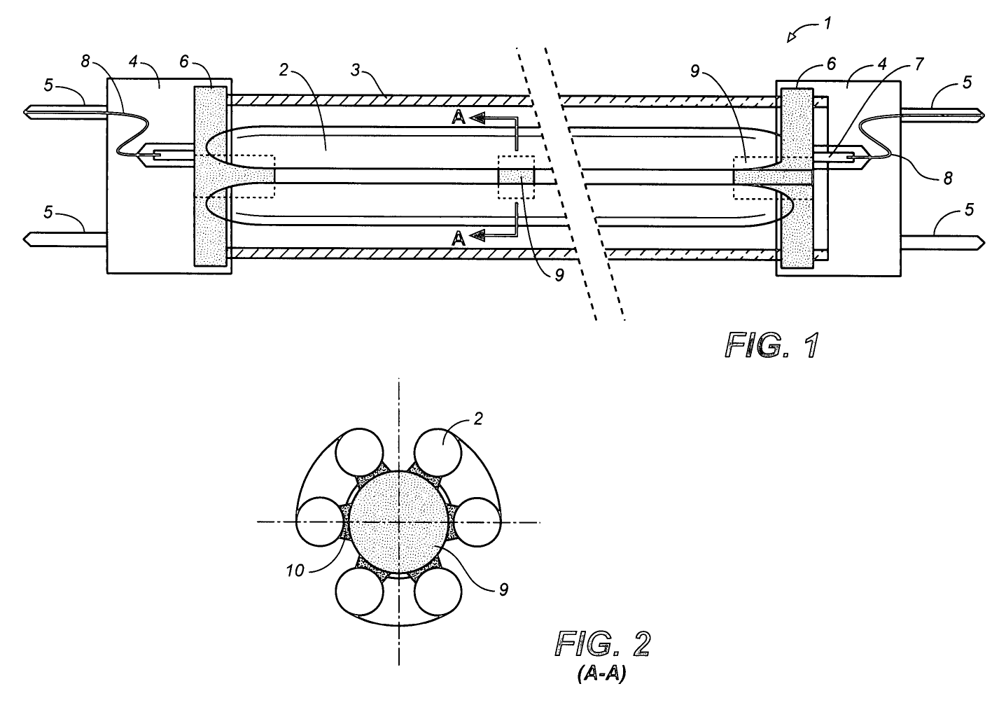

Referring to FIG. 1, the high power tubular cold cathode fluorescent lamp (CCFL lamp) 1 according to the present invention comprises at least one “U” shape or “multi-U” shape CCFL tube 2. FIG. 1 showed an example of “multi-U” shape CCFL tube. A light transmission tube 3. At least two fixtures 4 and at least two electric connectors 5 are used, each of the fixtures and connectors fixed at one of the ends of said light transmission tube 3. CCFL tubes 2 are installed in the light transmission tube 3 by the fixture 6 so that it is fixed in position relative to tube 3. The electrodes 7 of the CCFL tubes 2 are connected with the connector 5 through the metal lead 8. In order to increase the mechanical strength, the “U” shape or “multi-U” shape CCFL tubes 2 have at least one fixture or support 9 to fix the CCFL tubes 2 relative to tube 3. When a suitable voltage is applied to the connector 5, the CCFL lamp 1 will emit light. Support 9 attaches the CCFL tubes together to form a unitary structure for increased mechanical strength.

CCFL tubes 2 emit light of the same color. To change the light intensity of the CCFL tubes 2 by a dimmer (not shown in the Fig.) can dim the brightness of the CCFL lamp 1 by altering the electrical power signal applied to it by a driver (not shown in FIG. 1, but shown in other figures of this application). The CCFL lamp 1 is thus a dimmable lamp.

CCFL tubes 2 can also be designed to emit light of different colors, e.g., at least one CCFL tube is low color temperature, and at least one CCFL tube is high temperature, or at least one low color temperature and at least one green-blue CCFL tube. To adjust the light intensity of the different color CCFL tubes, the color temperature of the tubular CCFL lamp 1 can be adjusted by altering the electrical power signal applied to it by a driver (not shown in FIG. 1, but shown in other figures of this application). The CCFL lamp 1 is thus a color temperature adjustable and/or dimmable lamp. As described below, if the electrical power signal applied to the two types of lamps can be controlled separately, then it is possible to separately control the intensities of each type of CCFL, so as to arrive at a desired overall color temperature for the device or lamp 1, by altering their relative intensities. Alternatively the two types of lamps can be controlled together so that their intensities can be changed while their color temperature and relative intensities remain the same.

CCFL tubes 2 can comprise at least one set of red, green and blue CCFL tubes, or other colors CCFLs. To adjust the light intensity of the different color CCFL tubes, the different color light of the tubular CCFL lamp 1 or the color variable CCFL lamp 1 can be obtained. As described below, if the electrical power signal applied to the three types of lamps can be controlled separately, then it is possible to separately control the intensity of each type of CCFL, so as to arrive at a desired overall color for the device or lamp 1, by altering the relative intensities of the different types of CCFL. Alternatively the three types of lamps can be controlled together so that their intensities can be changed together while their relative colors remain the same. The CCFL lamp 1 is thus a color variable lamp.

Light transmission tube 3 can be a transparent, light diffusive or light transmissive only of light of certain colors, and made of glass or plastic. The shape of the cross section of the tube 3 can be a circle, semi-circle, ellipse, U shape, square, rectangle or other shapes. Fixture or support 9 may have a shape similar to that of tube 3; in addition support 9 may be conical in shape.

Fixtures 6 and 9 are soft fixtures, e.g., made of soft plastic or adhesive, or at least one is flexible to avoid damage the tubes 2 and 3 when the lamp working and the temperature of the tubes changes.

Said electrode 7 can be one of the existing CCFL electrode or neon lamp electrode.

FIG. 2 showed the cross section view A-A of FIG. 1. As shown in FIG. 2, the fixture or support 9 can be a glass or plastic post or tube (as shown in FIG. 4). The CCFL tube 2 is fixed on the surface of the fixture or support 9 by adhesive or plastic 10.

Electric connectors 5 can be similar to those of the existing conventional hot cathode tubular FL or one of the current lamp connectors, so that they would fit into conventional sockets for existing conventional hot cathode tubular FL.

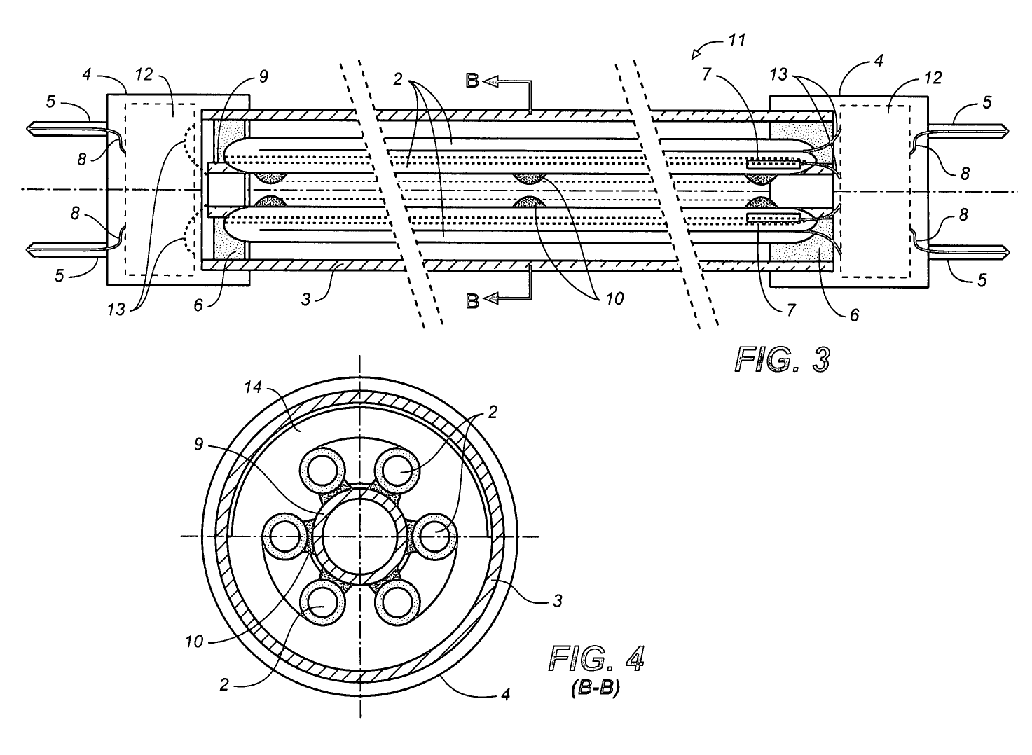

There is shown in FIG. 3, a second alternative embodiment of the high power tubular cold cathode fluorescent lamp 11 according to the present invention, where at least one high voltage transformer and its auxiliary components 12, e.g., capacitor, fuse etc. as a portion of the driver for the CCFL lamp 11 is installed in the fixture 4. The input of the transformer 12 connected to input electric power (e.g. power company outlet or DC supply, not shown) through the electric connector 5 and the leads 8, and the output is connected with the electrodes 7 of the CCFL tubes through the lead 13. The electric connector 5 is used for connecting with the other portion the driver of the CCFL lamp 11. In this manner, the high voltage output of the transformer is confined in location to the connection to electrodes 7, and improves safety of the lamp 11.

As shown FIGS. 3 and 4, there are three “U” shape CCFL tubes 2 installed in the light transmission tube 3. The CCFL tubes 2 are fixed on the surface of the fixture 9 by adhesive or plastic 10. The fixture 9 can be a glass or plastic tube or post (shown as FIG. 2). The fixture 9 can be a whole tube or at least two sections of the tube or post separated from one another (shown in FIG. 1). Support 9 may have a length that is commensurate with that of tube 3, and preferably is transparent Support 9 may comprise a glass, metallic or plastic material. The support 9 can have a solid or hollow body.

FIG. 4 is the cross sectional view along the line B-B of the CCFL lamp 11 shown in FIG. 3. The light transmission tube 3 has a reflective (e.g. mirrored or diffusively reflective) layer 14 on the portion of internal or outside surface of the tube 3.

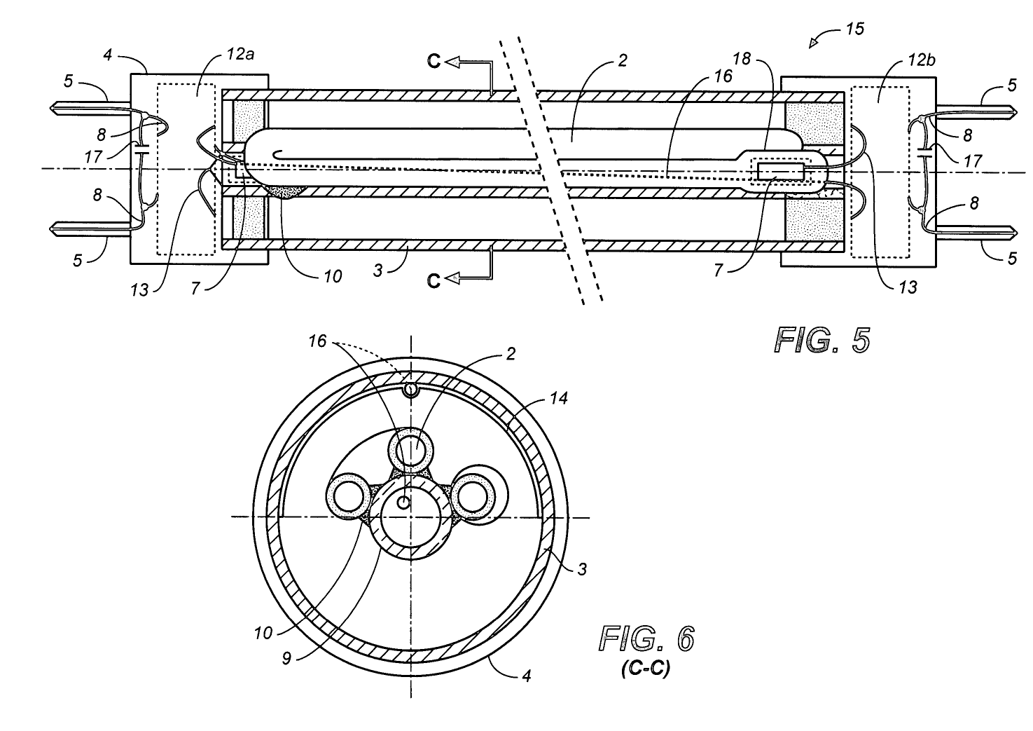

There is shown in FIG. 5, a third alternative embodiment of the high power tubular cold cathode fluorescent lamp 15 according to the present invention, where at least one “(n+½)U” shape CCFL tube 2 is used, where n is a an integer number of ≧1. The two ends and its electrodes 7 of each of the “(n+½)U” shape CCFL tube 2 set up at the two different directions of the CCFL tube as shown in the FIG. 5.

As shown in FIG. 5, the high voltage transformer for driving one CCFL tube is separated into two transformers 12a and 12b. The two transformers are operated at series connection. Numeral 16 is the label for the lead for connecting the two transformers. The input terminals of each of the transformers may be optionally connected to a capacitor 17 in parallel or in series.

As shown in FIG. 5, the diameter of the glass tube of the CCFL around the electrodes can be the same as or larger then the other portion of the CCFL tube. FIG. 5 illustrates an example of larger tube 18.

FIG. 6 is the cross sectional view along the line C-C of the CCFL lamp 15 shown in FIG. 5. The lead 16 for connection between the transformers can be installed through the fixture tube 9 or hidden between the reflective layer 14 and the tube 3.

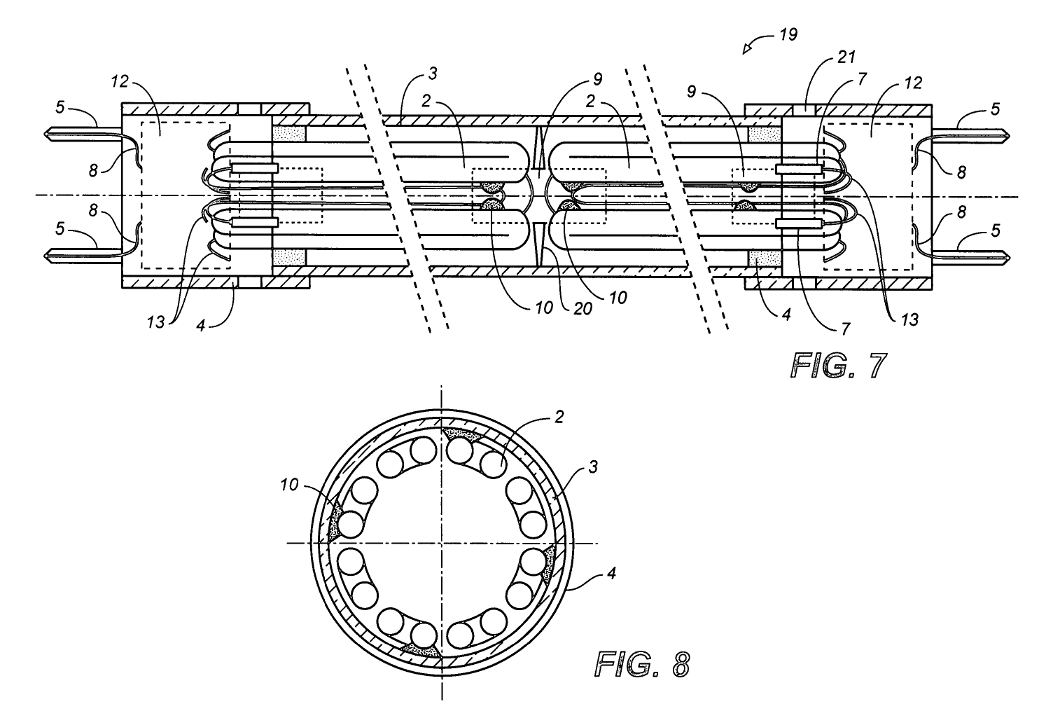

FIG. 7 is a schematic drawing showing a fourth alternative embodiment of the high power tubular cold cathode fluorescent lamp 19 according to the present invention, where more than two “U” shape or “multi-U” shape CCFL tubes 2 were used. Pairs of CCFL tubes are aligned along the same straight lines. Thus, within each pair, the bent ends of the two tubes are located at the center portion of tube 3 adjacent to each other, with their ends located near the ends of tube 3.as shown in FIG. 7. All the electrodes of the CCFL tubes are set up at the two terminals of the light transmission tube 3. All the CCFL tubes are fixed on the fixture 9. The fixture 9 can be a whole tube or at least two sections of the tube or post. In order to increase the mechanical strength, there is at least one support 20 between the fixture 9 and the tube 3. In order to disperse the heat which from electrodes and the transformers, there is at least one through hole 21 at the fixture 4.

FIG. 8 is another cross sectional view of the high power tubular cold cathode fluorescent lamp according to the present invention, where the CCFL tubes are fixed on the internal surface of the light transmission tube 3 by adhesive 10.

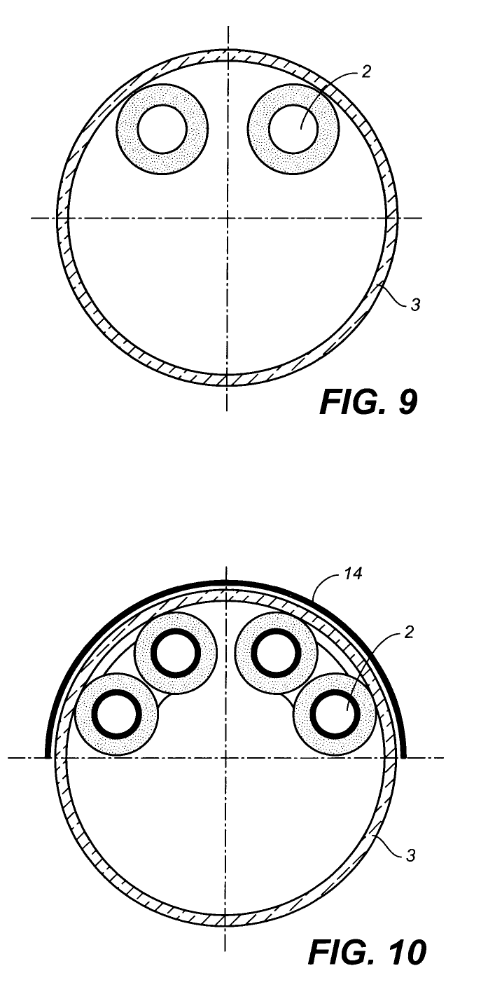

FIG. 9 is another cross section view of the high power tubular cold cathode fluorescent lamp according to the present invention, where the CCFL tube 2 is fixed on the top side of the light transmission tube 3.

FIG. 10 is another cross sectional view of the high power tubular cold cathode fluorescent lamp according to the present invention, where the CCFL tubes 2 are fixed on the top side of the tube 3, and the reflective layer in on the outside surface of the tube 3.

FIG. 11 is another cross sectional view of the high power tubular cold cathode fluorescent lamp according to the present invention, where the CCFL tubes 2 are fixed on the bottom or top side of the light transmission tube 3. The light transmission tube 3 is made of two portions of 3a and 3b. The reflective layer 14 is on the top portion surface of the tube 3a.

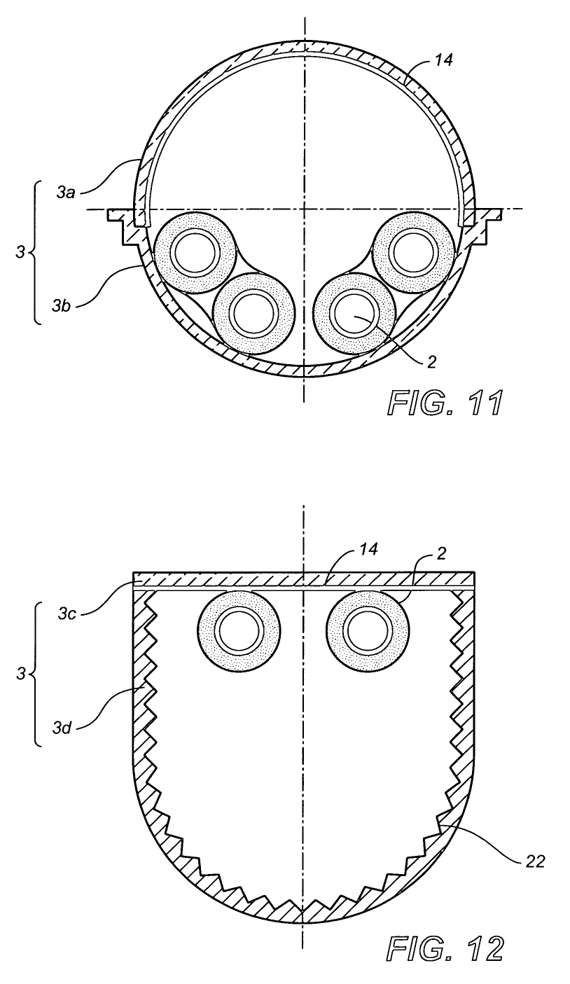

FIG. 12 is another cross sectional view of the high power tubular cold cathode fluorescent lamp according to the present invention, where the light transmission tube 3 is made of two portions 3c and 3d. The portion 3d is U shape or other shapes in cross section. The reflective layer 14 is on the top portion flat surface 3c of the tube. The portion 3d can have a series of small prisms or lenses 22.

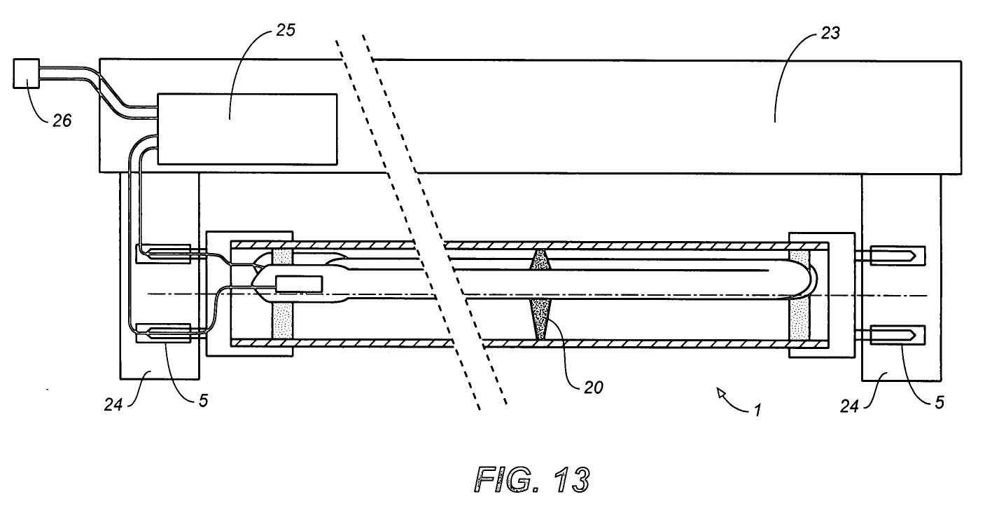

There is shown in FIG. 13, an embodiment of the high power tubular cold cathode fluorescent lamp with the driver and the base 23 according to the present invention, where at least one high power tubular cold cathode fluorescent lamp 1 is installed. A base 23 is used for the CCFL lamp 1. Two connectors 24 are installed on the base for installing CCFL lamp 1. A driver 25 is installed in the base. The input of the driver 25 is connected to an electric connector 26 for connecting to DC or AC electric power (not shown). The output of the driver 25 is connected to the CCFL lamp 1 to drive the lamp. The driver 25 can be a DC/AC or AC/AC inverter. It can provide a suitable voltage to drive the CCFL lamp.

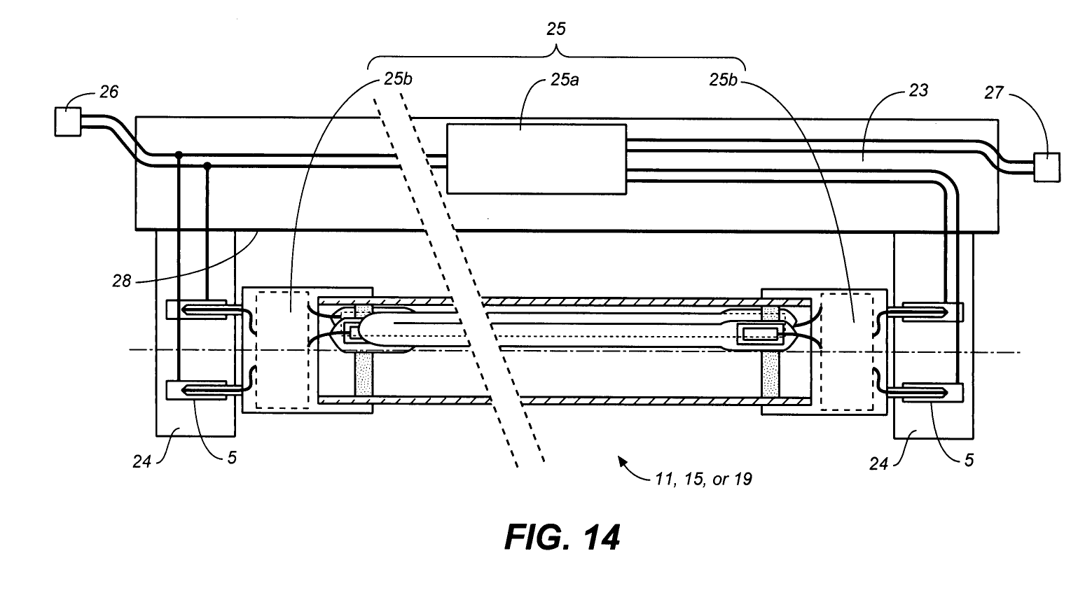

There is shown in FIG. 14, an alternative embodiment of the high power tubular cold cathode fluorescent lamp with the driver and the base according to the present invention, where at least one high power tubular cold cathode fluorescent lamp 11, 15 or 19 is installed at the connectors 23. The driver 25 is separated to two portions of 25a and 25b. The 25b can be the same as transformer 12 mentioned above. The driver portion 25a can drive the other CCFL lamp through the connector 27. The surface of the base faces to the CCFL lamp can have a reflector 28, which is flat surface or a curves surface. Thus, driver portion 25a can be a converter circuit that converts input electric power to an AC output in the range of about 5-400 volts and at a frequency in the range of about 1 kc-800 kc. This AC output is then boosted to a high voltage (e.g. several thousand volts) by transformer 25b for powering the CCFLs.

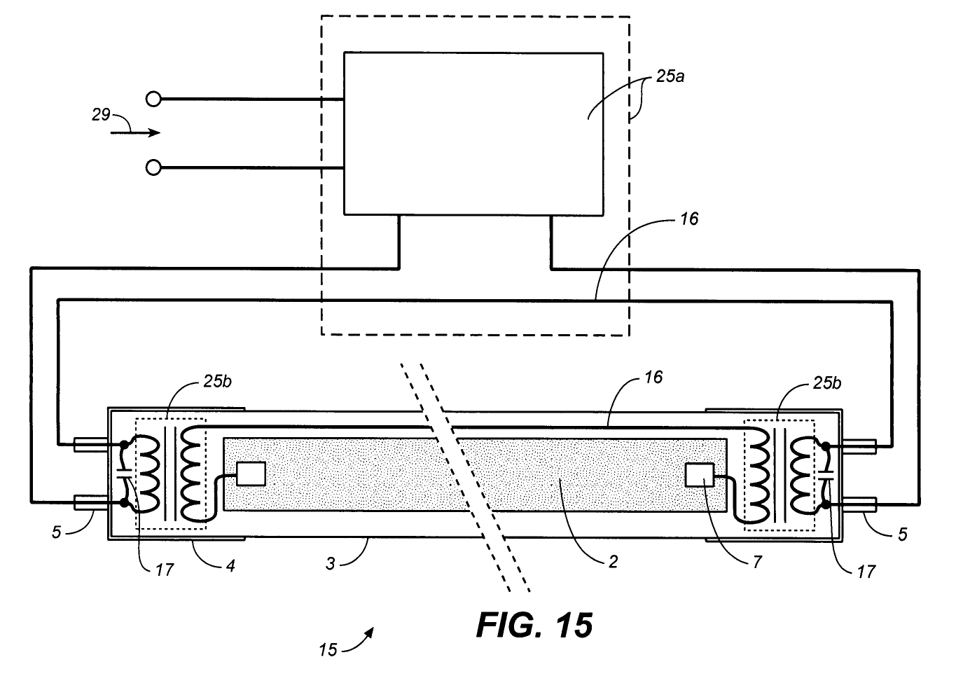

FIG. 15 is a schematic diagram of the circuit for driving CCFL lamp 15 as shown in FIG. 5. 29 is the DC or AC electric power. Each of the driver portions 25b includes a high voltage transformer and (or not) a capacitor 17.

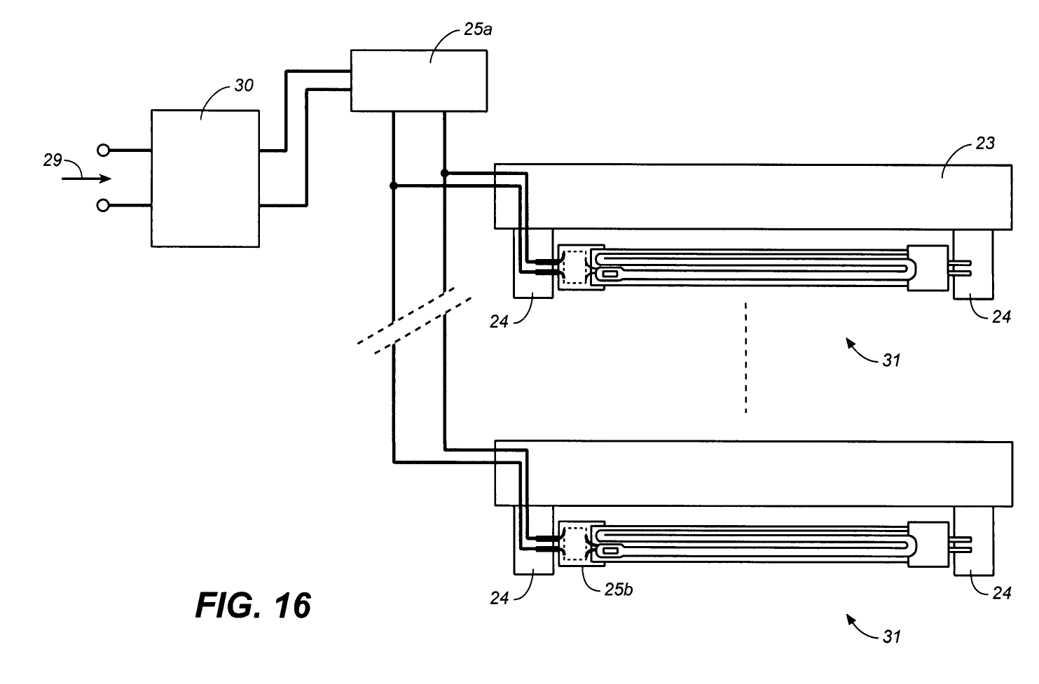

FIG. 16 is a schematic diagram of the circuit for driving multi CCFL lamps 31, where the CCFL lamp 31 is one of the CCFL lamps or devices described above. Numeral 30 is the label for a controller for CCFL lamp lighting, e.g., a manual, IR, RF or program controller. One driver 25a can drive one or more CCFL lamps. Thus, all of the CCFL lamps or devices are controlled by the same driver circuit 30, which may comprise a converter circuit that converts input electric power to an AC output in the range of about 5-400 volts and at a frequency in the range of about 1 kc-800 kc. This AC output is supplied to each of the CCFL lamps, where such output is then boosted to a high voltage by the transformer 25b in each of the lamps. In this manner, all of the lamps are controlled by the same driver circuit, and will be boosted in light emission or dimmed by the same amount, so that the relative light intensities emitted by all the lamps 31 are maintained substantially constant.

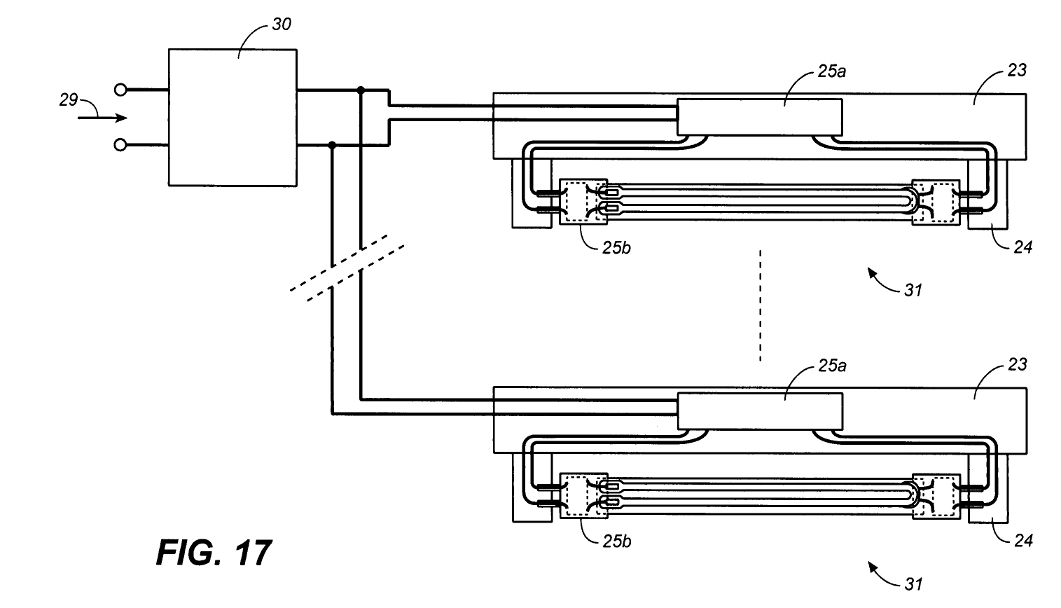

FIG. 17 is a schematic diagram of an alternative circuit for driving multi CCFL lamps 31. In contrast to the embodiment of FIG. 16, each of the lamps has its own driver circuit 25a, so that the different AC outputs may be applied to the lamps, so that the intensities of the lamps can be controlled individually and separately from one another to achieve the desired overall color temperature.

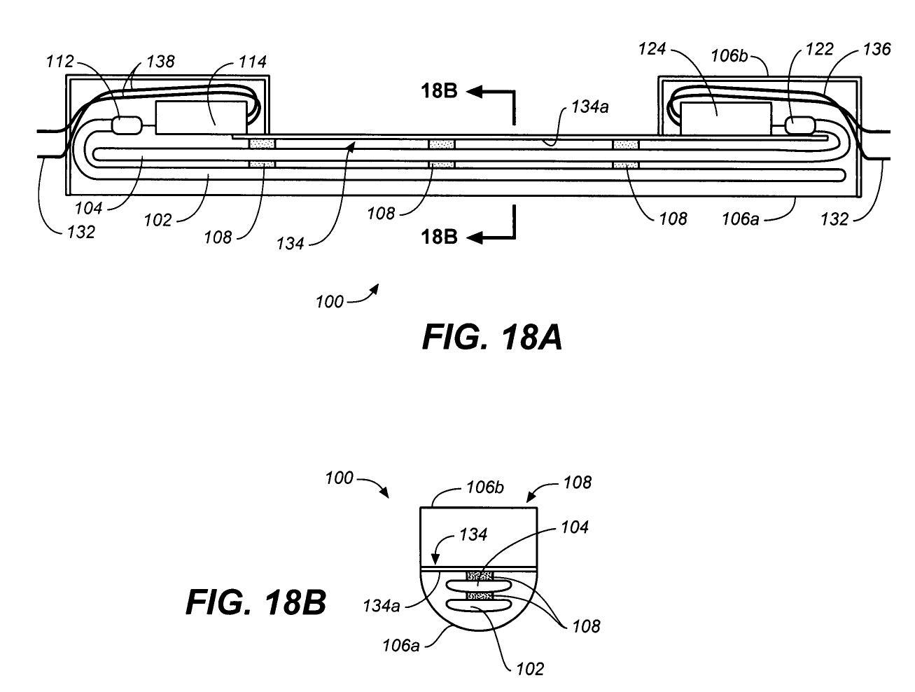

FIG. 18A is a schematic drawing showing an alternative embodiment of the high power tubular cold cathode fluorescent lamp 100 with CCFLs that are bent near one end, so as to avoid dark ends.

FIG. 18B is a cross sectional view of FIG. 18A along the line 18B-18B in FIG. 18A. The ends of CCFL tubes normally appear to be darker than other portions of the tubes. To avoid such effects, the ends of the CCFL tubes 102, 104 may be bent back towards itself to form a small U-shaped portion as shown in FIG. 18A. The tubes emit light in directions downwards in FIG. 18A towards the portion 106a of the light transmissive container or housing 106. The direction of bending is away from such light emission directions so as not be block the light emitted by tubes 102, 104. As shown in FIG. 18A, the electrodes 112, 122 of the CCFL tubes are connected to transformers 114, 124 respectfully. Thus the transformers 114, 124 are located adjacent to the electrodes to which they are connected, thereby reducing the danger of the high voltage in such connections to users and consumers. The transformers 114, 124 are connected to power supplies through wires 136, 138 and connectors 132. The transformers and bent ends of the CCFL tubes are housed in portions 106b of the container 106. Tubes 102, 104 may be fixed in position relative to container 106 by means of a plate 134 attached to container 106, where plate is attached to tube 104 by adhesive 108. Tube 104 is attached to tube 102 by adhesive 108 as well. A light reflective layer is formed on plate 134 to reflect light downwards towards portion 106a.

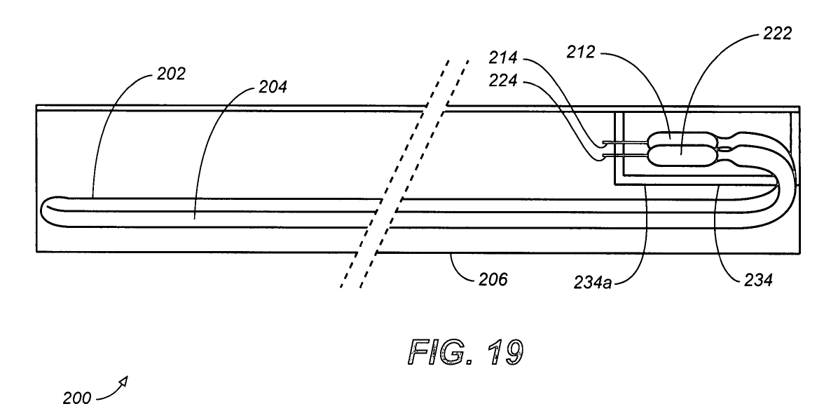

FIG. 19 is a schematic drawing showing another alternative embodiment of the high power tubular cold cathode fluorescent lamp with CCFLs that are bent near one end, so as to avoid dark ends, where the CCFLs are placed in a tandem arrangement.

FIG. 20 is a schematic drawing showing a (1+½)U shaped CCFL to illustrate an embodiment of the high power tubular cold cathode fluorescent lamp.

The foregoing embodiments are merely exemplary and are not to be construed as limiting the present invention. The present teaching can be readily applied to other types of apparatuses. The description of the present invention is intended to be illustrative, and not to limit the scope of the claims. Many alternatives, modifications and variations will be apparent to those skilled in the art. All references referred to herein are incorporated by reference.

What is claimed is:

1. A high power tubular CCFL device, comprising:
at least one CCFL;
a larger diameter light transmission tube having two ends, said at least one CCFL at a fixed location inside the light transmission tube;
at least two fixtures, each of the two fixtures at one of the two ends of the light transmission tube;
at least two connectors, each of the two connectors at one of the two ends of the light transmission tube for connection to input electric power;
a driver having a portion in one of said fixtures, said fixtures connecting said light transmission tube, the CCFL(s) and the connectors, wherein when input electric power is supplied to the connectors, the portion of the driver will cause suitable voltage to e supplied to cause the CCFL to supply light;

2. The CCFL device of claim 1, the portion of the driver comprising at least one high voltage transformer.

3. The CCFL device of claim 2, the portion of the driver further comprising an electric circuit which comprises a capacitor and/or fuse, said capacitor connected with the transformer in parallel or series.

4. The CCFL device of claim 1, said connectors adapted to be connected to sockets suitable for connection to hot cathode fluorescent lamps.

5. The CCFL device of claim 1, the portion of the driver further comprising an electric circuit that converts input electric power from said connector to an AC output supplied to the at least one high voltage transformer at a voltage in the range of about 5-400 volts and at a frequency in the range of about 1 kc-800 kc.

6. The CCFL device of claim 5, further comprising:
a base portions with two ends, said circuit located inside the base; and
two support structures connected to the two ends of the base, said structures connected to and supporting said light transmission tube and forming a lighting system.

7. The CCFL device of claim 1, wherein said at least one shaped CCFL tube is the shape of a straight line, “U”, multi-“U” shape, “(n+½)U”, shape “H” shape, multi-“H” shape or “(n+½)H” shape CCFL tube, where n is an integer number of ≧1.

8. The CCFL device of claim 7, said device comprising at least one serpentine or H-shaped CCFL or two U-shaped CCFLs with the bent ends of the two CCFLs placed adjacent each other at a center location in the light transmission tube with the ends of the two CCFLs located near the ends of the light transmission tube.

9. The CCFL device of claim 1, said device comprising at least two CCFLs emitting light of the same light color or different light color.

10. The CCFL device of claim 9, said device comprising:
at least one set of red, green and blue light color emitting CCFLs; and further comprising:
a driver controlling power supplied to the CCFLs to change the relative light intensities of the red, green and blue light emitted by the CCFLs so that the device is a light color variable lamp and/or a light color variable and dimmable lamp.

11. The CCFL device of claim 9, wherein said at least two CCFLs comprise at least one high color temperature light tube and at least one low color temperature light tube, or at least one low color temperature light tube and at least one green-blue color light tube.

12. The CCFL device of claim 11, further comprising a driver controlling power supplied to the CCFLs to change the relative light intensities of the light emitted by the high and low color temperature CCFL tubes, or emitted by the low color temperature light tube and the green-blue color light tubes, to obtain different color temperature light, so that the device is a light color temperature adjustable lamp and/or a color temperature adjustable and dimmable lamp.

13. The CCFL device of claim 1, further comprising a support supporting said at least one CCFL, and a soft adhesive attaching the at least one CCFL to the support, said transparent support having a circular, elliptical, square or rectangular cross-section, or a conical shape.

14. The CCFL device of claim 1, further comprising a support supporting said at least one CCFL, said support having a length commensurate with length of the light transmission tube.

15. The CCFL device of claim 1, further comprising a support supporting said at least one CCFL, said support comprising a plurality of sections separated from one another.

16. The CCFL device of claim 1, further comprising a transparent support supporting said at least one CCFL, said transparent support comprising a glass, metallic or plastic material, said support comprising a solid or hollow body.

17. The CCFL device of claim 1, wherein said at least one shaped CCFL tube is attached to an internal surface of said light transmission tube.

18. The CCFL device of claim 1, wherein said light transmission tube has a circular, semi-circular, elliptical, square or rectangular cross-section, or a cross-section that is a straight line on one side combined with a U-shape.

19. The CCFL device of claim 18, further comprising a light reflective layer on said light transmission tube, said reflective layer comprising a mirrored or diffusive reflective surface

20. The CCFL device of claim 19, further comprising prisms or lenses in a portion of said light transmission tube.

21. The device of claim 1, the at least one CCFL comprising at least one electrode, said transformer located adjacent to and connected to the at least one electrode.

22. The device of claim 1, wherein said at least one CCFL emits light for illumination along directions, and at least one CCFL comprises one end that is bent into a substantially U-shaped or H-shaped portion along a direction that does not block light emitted by the at least one CCFL.

23. The device of claim 1, said device comprising a plurality of CCFLs, said device further comprising a support supporting said CCFLs, so that the CCFLs are attached together to form a unitary mechanical structure for increased mechanical strength.

24. A high power tubular CCFL device, comprising:
two or more CCFLs;
a driver circuit converting input electric power to an AC output in the range of about 5-400 volts and at a frequency in the range of about 1 kc-800 kc; and
at least one high voltage transformer responsive to said AC output to cause suitable voltage(s) to be supplied to the CCFLs to cause the CCFLs to supply light.

25. The device of claim 22, said device comprising two or more CCFL lamp units, each unit comprising a light transmission tube and a CCFL fixed in position in such tube.

26. The device of claim 25, said device comprising a plurality of high voltage transformers, each of said CCFL lamp units comprising one of said plurality of high voltage transformers for supplying a suitable voltage to the CCFL of such unit.

27. The device of claim 26, driver circuit applying to the two or more CCFLs AC outputs that are the same or different from one another, so that the two or more CCFLs are individually controlled to emit light of the same or different intensities.

28. The device of claim 25, further comprising:
a base with two ends, said circuit and said at least one high voltage transformer located inside the base; and
two support structures connected to the two ends of the base, said structure connected to and supporting said light transmission tubes of the units;
wherein said driver circuit drives one or more CCFL lamp unit and said base, support structures, and CCFL lamp units forming a lighting system.
